(19) United States
(12) Patent Application Publication
(10) Pub. No.: US 2026/0367474 A1
(43) Pub. Date: Nov. 19, 2026

(54) Device and Method for Frequency Conversion of Electromagnetic Radiation

(71) Applicant: Fraunhofer-Gesellschaft zur Förderung der angewandten Forschung e.V., München (DE)

(72) Inventors: Bernd JUNGBLUTH, Aachen (DE); Florian ELSEN, Aachen (DE); Sebastian NYGA, Aachen (DE); Jan Fabian GEUS, Aachen (DE)

(21) Appl. No.: 18/611,905

(22) Filed: Mar. 21, 2024

Related U.S. Application Data
(63) Continuation of application No. PCT/EP2022/076420, filed on Sep. 22, 2022.

(30) Foreign Application Priority Data
Sep. 24, 2021 (DE) 10 2021 210 706.0

(51) Int. Cl. G02F 1/35; G02F 1/355

(52) U.S. Cl. CPC G02F 1/3534; G02F 1/3501; G02F 1/3553

(57) ABSTRACT

A device for frequency conversion of electromagnetic radiation has a non-linear medium. The device is configured to superimpose electromagnetic input radiation of a first wavelength in the non-linear medium with electromagnetic driving radiation of a second wavelength along a propagation path in order to generate electromagnetic output radiation of a third wavelength. The second wavelength is longer than the first wavelength. Furthermore, the non-linear medium is configured for free propagation of the driving radiation in the non-linear medium.

### CROSS-REFERENCE TO RELATED APPLICATIONS

This application is a continuation of copending International Application No. PCT/EP2022/076420, filed Sep. 22, 2022, which is incorporated herein by reference in its entirety, and additionally claims priority from German Application No. 10 2021 210 706.0, filed Sep. 24, 2021, which is also incorporated herein by reference in its entirety.

### TECHNICAL FIELD

Embodiments of the present invention relate to a device for frequency conversion of electromagnetic radiation, in particular a frequency converter for converting single photons, in particular a quantum frequency converter. Further embodiments relate to a method for frequency conversion of electromagnetic radiation.

### BACKGROUND OF THE INVENTION

The subject of current research is the implementation of networks between quantum computers. Since the fluorescence wavelengths of the quantum bits (qubits, the computing units of a quantum computer) are usually not in the range of telecommunication wavelengths (1260 nm-1675 nm), a conversion step is necessary to reduce propagation losses during transmission through optical fibers [1].

The frequency conversion of these optical signals results in special requirements to a frequency converter which are not relevant for classic frequency conversion. In contrast to classic optical communication, the information to be transported is encoded in individual photons and not in fields of macroscopic intensity. Therefore, the fidelity of the transmission is reduced by every additionally introduced photon of the same wavelength (i.e. from a different source). These photons are called noise photons.

Consequently, the rate of introduced noise photons is to be low at every point of the transmission path. This applies in particular to the conversion process, which can be realized, for example, by superimposing the photons to be converted with another field in a non-linear medium.

In previous frequency converters, the conversion process takes place in waveguide structures in periodically poled non-linear media, e.g. in lithium niobate [2], [3], [4], [5], or in potassium titanyl phosphate [6]. In addition to the radiation field to be converted (“input signal, field” with the wavelength λᵢₙ), a further field of high average power is incident, wherein optical-to-optical conversion efficiencies of the order of quantum efficiency (n_{Q}=λₒᵤₜ/λᵢₙ) are achieved. Here, Nout denotes the wavelength of the converted field (“output signal or field”).

However, the presence of a high-power field in a non-linear medium causes photons to be generated in all spectral regions of longer wavelengths and therefore also in the output channel, in particular due to a process called spontaneous parametric down-conversion (SPDC).

The rate of generated noise photons in the existing systems is at least 150 Hz/pm, e.g. in relation to the half-width of the spectral filters of the optical output.

Given the state of the art, it would be desirable to provide a frequency conversion concept which offers an improved ratio between a high conversion efficiency and a low rate of noise photons. In particular, it would be desirable for the concept to have a low efficiency of the SPDC process in generating photons of the output wavelength and nevertheless offer a conversion efficiency of the order of quantum efficiency.

### SUMMARY

An embodiment may have a device for frequency conversion of electromagnetic radiation, the device having a non-linear medium, the device being configured to superimpose electromagnetic input radiation of a first wavelength in the non-linear medium with electromagnetic driving radiation of a second wavelength along a propagation path in order to generate electromagnetic output radiation of a third wavelength, wherein the second wavelength is greater than the first wavelength, wherein the second wavelength is smaller than the third wavelength, and wherein the non-linear medium is configured for free propagation of the driving radiation in the non-linear medium.

According to another embodiment, a method for frequency conversion of electromagnetic radiation may have the step of: superpositioning electromagnetic input radiation of a first wavelength with electromagnetic driving radiation of a second wavelength along a propagation path in a non-linear medium to generate electromagnetic output radiation of a third wavelength such that the second wavelength is longer than the first wavelength, such that the second wavelength is smaller than the third wavelength and such that the driving radiation propagates freely in the non-linear medium.

The present invention is based on the finding that an efficient and low-noise frequency conversion can be achieved by superimposing electromagnetic input radiation with electromagnetic driving radiation along a propagation path in a non-linear medium by dispensing with waveguiding of the driving radiation in the non-linear medium and, additionally, by selecting the wavelength of the driving radiation to be greater than the wavelength of the input radiation. Inaccuracies when manufacturing a waveguide are a major source of noise photons in conventional frequency converters. Until now, however, it has been assumed that an implementation without waveguiding is disadvantageous in terms of higher power densities of the driving radiation since a high rate of noise photons can arise due to the interaction of high-power driving radiation with the non-linear medium. However, the inventors have recognized that due to a longer wavelength of the driving radiation compared to the wavelength of the input radiation, phonon bands generated by the driving radiation are located less or do not fall into the wavelength range of the output radiation, and thus low-noise conversion is possible. Although in a conversion process based on three-wave mixing, a higher conversion efficiency would be expected if the wavelength of the driving radiation were selected as the shortest wavelength, it has been recognized that it is of advantage in terms of the conflicting goals of high conversion efficiency and low rate of noise photons to operate the conversion based on a driving radiation with a wavelength greater than the wavelength of the input radiation, and that this even allows a power density of the driving radiation with which, without waveguiding, high conversion efficiency can be achieved. Thus, embodiments allow a low-noise and efficient conversion of photons, thereby allowing a good signal-to-noise ratio.

Embodiments of the present invention provide a device for frequency conversion of electromagnetic radiation, for example a device for frequency conversion of single photons, in particular for frequency conversion of single photons while preserving quantum information. The device has a non-linear medium. The device is configured to superimpose electromagnetic input radiation of a first wavelength in the non-linear medium with electromagnetic driving radiation of a second wavelength along a propagation path in order to generate electromagnetic output radiation of a third wavelength. For example, the device is configured to collinearly superimpose or mix the driving radiation and the input radiation along the propagation path. According to the invention, the second wavelength is greater than the first wavelength. Furthermore, the non-linear medium is configured for free propagation of the driving radiation in the non-linear medium or through the non-linear medium. That is, for example, the non-linear medium (or device) does not have waveguiding properties, or a waveguiding structure, for propagating the driving radiation along the propagation path, e.g. properties which spatially limit the driving radiation propagating along the propagation path. Thus, the device can be configured for propagation of the driving radiation without waveguiding in the non-linear medium.

According to embodiments, the device further comprises a resonator resonant for the second wavelength. The propagation path of the non-linear medium, i.e. the propagation path in the non-linear medium, along which the driving radiation and the input radiation are superimposed, is arranged in the resonator to provide the driving radiation along the propagation path. For example, the propagation path is arranged in an optical path of the resonator. The use of a resonator is an energy-efficient way of providing a high power density of the driving radiation in the non-linear medium. A high intensity of the driving radiation ensures a high conversion efficiency of a second-order non-linear conversion process, in particular three-wave mixing between photons of the input radiation, the driving radiation and the output radiation. The use of a resonator makes allows providing the driving radiation with high power as well as with high beam quality and narrow spectral bandwidth. In particular, this can be achieved cost-effectively by means of the resonator.

According to embodiments, the second wavelength is smaller than the third wavelength. According to these embodiments, the second wavelength can thus be the middle wavelength in a three-wave mixture. For these cases of the ratio of the three wavelengths, the implementation of frequency conversion with free propagation in the non-linear medium according to the invention is of particular advantage since a low rate of noise photons can be achieved by this, although the wavelength of the driving radiation is shorter than the wavelength of the output radiation.

According to embodiments, the device is configured to focus the driving radiation in the non-linear medium onto a focus with a cross-sectional size of 2*w₀. For example, the cross-sectional size is a maximum size of a beam cross-section in the focus, e.g. w₀ is the radius of the focus in the case of a circular beam cross-section. According to these embodiments, a length L of the non-linear medium along the propagation path fulfills the following condition:

$$L \leq {z}_{R} * \sqrt{\frac{1}{3} {( \frac{D}{{w}_{0}} )}^{2} - 4} ,$$

where z_{R} denotes the Rayleigh length for the driving radiation, and where D denotes a size of an aperture of the non-linear medium, for example a size in the spatial direction in which w₀ is measured. The aperture may, for example, denote a cross-section or a diameter of a free area of an inlet facet through which the propagation path passes or through which the driving radiation and the input radiation enter the non-linear medium. For example, D can denote the smallest free diameter of the aperture. Such a length L of the non-linear medium can ensure that the driving radiation is not reflected at interfaces of the non-linear medium which run in parallel to the propagation path, but that the driving radiation emerges from the non-linear medium instead.

According to embodiments, the non-linear medium along the propagation path has a length in the range of 2 mm to 60 mm. A short length allows achieving very precise phase matching between the input radiation, the driving radiation and the output radiation over the length of the propagation path. On the other hand, a long length allows positioning a focus of the driving radiation, the input radiation and the output radiation further away from an inlet facet and an outlet facet of the non-linear medium, wherein a power density on the inlet facet and the outlet facet can be kept low. In addition, the conversion efficiency also increases with an increasing interaction length up to a value at which the phase position of the three fields can have a disadvantageous effect.

According to embodiments, the device is configured to focus the driving radiation in the non-linear medium. Thus, the Rayleigh length of the focus of the driving radiation in the non-linear medium is at most the Rayleigh length of a corresponding Gaussian beam, i.e. a Gaussian beam of the same wavelength and the same cross-sectional size in the focus as the driving radiation. In other words, there is no waveguiding in the non-linear medium.

According to embodiments, the device is configured to focus the driving radiation onto a focus in the non-linear medium. Thus, the device is configured to provide the driving radiation in the focus with a power density, for example a power per area of the beam cross-section in the focus, for example an average power density, averaged over the beam cross-section area, of at least 2/π·10⁵ W/cm² or at least 2/π·10⁶ W/cm². With a power density above this limit, a particularly high efficiency of the conversion process can be achieved, especially in the order of quantum efficiency. Up to now, it has been assumed that the high power density for frequency conversion without a waveguide structure is an obstacle to implementation without a waveguide structure. On the one hand, the used power density was considered to be so high that destruction of the non-linear medium was expected. On the other hand, the increase in temperature in the non-linear medium caused by the high power density was considered to be of disadvantage for the conversion process. However, it was recognized that a high conversion efficiency can be achieved by a high power density even without waveguiding, and that an improved compromise between conversion efficiency and noise can be achieved, especially in combination with a longer wavelength driving radiation compared to the input radiation.

According to embodiments, an aperture of the non-linear medium has a size of 0.5 mm to 10 mm in a first direction. Furthermore, the aperture has a size of 0.5 mm to 10 mm in a second direction perpendicular to the first direction. An aperture with a size of at least 0.5 mm ensures a low power density on an inlet facet and/or an outlet facet of the non-linear medium. An aperture of at most 10 mm ensures a cost-efficient and space-saving implementation of the device.

According to embodiments, the non-linear medium has a uniform second order electrical susceptibility along the propagation path. In the case of periodic poled non-linear media, inaccuracy in the periodicity of the polarity of the non-linear medium can contribute to the generation of noise photons. Consequently, a particularly low-noise conversion can be achieved if the non-linear medium has a uniform polarity along the propagation path.

According to embodiments, the second-order electrical susceptibility of the non-linear medium has a periodically changing sign along the propagation path. Due to a periodically changing polarity of the non-linear medium along the propagation path, the phases of the input radiation, the output radiation and the driving radiation can be matched to one another particularly well, especially for a long length of the non-linear medium. Precise phase matching increases the efficiency of the conversion process, which means that a lower power density may be sufficient, for example.

According to embodiments, the propagation path passes between an inlet facet and an outlet facet of the non-linear medium. For example, the propagation path passes from the inlet facet to the outlet facet of the non-linear medium. According to these embodiments, the inlet facet encloses an angle in a range from 0° to 10° with a plane perpendicular to the propagation path. Furthermore, the outlet facet encloses an angle in a range from 0° to 10° with a plane perpendicular to the propagation path. In examples, the angle for the inlet facet and/or for the outlet facet is greater than 0°. For example, the angles of the inlet facet and the outlet facet are in a range from 2° to 10°. An angle of more than 0° prevents backward propagation of the driving radiation, i.e. electromagnetic radiation which propagates through the non-linear medium along the propagation path and is reflected at the outlet facet of the non-linear medium cannot travel in the opposite direction of the propagation path.

According to embodiments, the device is configured to superimpose the input radiation in the non-linear medium with the driving radiation such that the input radiation and the driving radiation match in their beam directions. High efficiency of the conversion process can be ensured by matching the beam direction.

According to embodiments, the third wavelength is in a range from 1260 nm to 1675 nm. Thus, the sum of the reciprocals of the second and third wavelengths corresponds to the reciprocal of the first wavelength. Electromagnetic radiation with a wavelength in the aforementioned range can be transmitted with particularly low loss using waveguides so that these wavelength ranges are well suited for communication over longer distances.

According to embodiments, the device has a further resonator resonant for the second wavelength. A further propagation path is arranged in the further resonator. The further propagation path passes through a further non-linear medium. According to these embodiments, the device is configured to superimpose further electromagnetic input radiation with further electromagnetic driving radiation of the second wavelength along the further propagation path in order to generate further electromagnetic output radiation. According to these embodiments, the device is configured to use a portion of the driving radiation coupled out of the resonator to provide the further driving radiation in the further resonator. In other words, the device may comprise a plurality of frequency converter modules, each of which is configured to convert respective input radiation into respective output radiation. Using the radiation coupled out of the resonator in the further resonator allows energy efficient operation of a plurality of frequency converters. In particular, energy-efficient operation is made possible by the fact that the wavelength of the driving radiation is longer than the wavelength of the input radiation. The intensity of the driving radiation is not reduced when converting the input radiation into the output radiation, but rather increased.

According to embodiments, the device further comprises an amplifier configured to amplify the portion of the driving radiation coupled out of the resonator and to supply the amplified driving radiation to the further resonator so that the driving radiation in the resonator and the further driving radiation in the further resonator have the same intensity. Identical intensities in the resonators can ensure identical efficiency of the conversion process of the respective non-linear media.

According to embodiments, the material of the non-linear medium is one of beta barium borate, beta BaB₂O₄, lithium niobate, LiNbO₃ or MgO:LiNbO₃, lithium tantalate LiTaO₃ or MgO:LiTaO₃, potassium titanyl arsenate, KTiOAsO₄, potassium titanyl phosphate, KTiOPO₄, lithium triborate, LiB₃O₅, and bismuth triborate, BiB₃O₆. These materials offer high efficiency for second-order conversion processes.

According to embodiments, the third wavelength is in a range from 1260 nm to 1675 nm, and the first wavelength is in a range from 200 nm to half the third wavelength. In this range for the first wavelength, emission wavelengths of quantum bits can be realized particularly well. In particular, the first wavelength may be in a range from 600 nm to 650 nm. In the latter range, quantum bits can be implemented particularly advantageously in the form of nitrogen defects. Conversion in these wavelength ranges can be implemented advantageously, particularly in combination with materials mentioned before.

According to embodiments, the device is configured to maintain a temperature of the non-linear medium at a temperature T during operation, wherein T is between 0 °C and 200 °C. Furthermore, according to these embodiments, the material of the non-linear medium is KTA. A first crystallographic axis of the non-linear medium encloses an angle θ=90° with the propagation path. Furthermore, a projection of the propagation path into a plane spanned by a second crystallographic axis and a third crystallographic axis of the non-linear medium encloses an angle Φ with the second crystallographic axis. The refractive index along the first crystallographic axis is greater than the refractive index along the second crystallographic axis, and the refractive index along the second crystallographic axis is greater than the refractive index along the third crystallographic axis. Furthermore, the first wavelength is in a range from 350 nm to 840 nm and the third wavelength is in a range from 1260 nm to 1675 nm. The sum of the reciprocals of the second and third wavelengths corresponds to the reciprocal of the first wavelength. Furthermore, the second wavelength is smaller than the third wavelength Furthermore, the following applies for the angle φ:

$$ϕ = {ϕ}_{0} + \frac{\partial ϕ}{\partial λ} Δλ + \frac{\partial ϕ}{\partial λ} \frac{\partial λ}{\partial T} Δ T , with T = 80 °C + Δ T ; λ = 1064 nm + Δλ ; \\ {ϕ}_{0} = 33 ° \pm 1 ° ; \frac{\partial ϕ}{\partial λ} = - 0.9 ° / nm \pm 0.3 ° / nm ; and \frac{\partial λ}{\partial T} = 0.05$$

nm/°C±0.025 nm/°C.

The inventors have recognized that KTA in particular is well suited for frequency conversion since a particularly efficient conversion is possible along the directions defined above, thus enabling low-noise and efficient conversion, in particular also for the specified wavelength ranges for a conversion of wavelengths of stable quantum bits in the telecom wavelength range. Due to the high efficiency of the conversion, it is possible to keep the power density of the driving radiation so low that the non-linear medium is stable and, furthermore, low-noise conversion is possible. It was recognized that it is possible to achieve conversion efficiency in the order of quantum efficiency without using a waveguide structure if the propagation path in KTA along a certain orientation is chosen.

According to embodiments, the device is configured to maintain a temperature of the non-linear medium at a temperature T during operation, wherein T is between 0 °C and 200 °C. Furthermore, according to these embodiments, the material of the non-linear medium is KTA. A first crystallographic axis of the non-linear medium encloses an angle θ=90° with the propagation path. Furthermore, a projection of the propagation path into a plane spanned by a second crystallographic axis and a third crystallographic axis of the non-linear medium encloses an angle φ with the second crystallographic axis. The refractive index along the first crystallographic axis is greater than the refractive index along the second crystallographic axis, and the refractive index along the second crystallographic axis is greater than the refractive index along the third crystallographic axis. Furthermore, the first wavelength is in a range from 600 nm to 700 nm and the third wavelength is in a range from 1260 nm to 1675 nm. Alternatively, the first wavelength is in a range from 635 nm to 640 nm and the third wavelength is in a range from 1260 nm to 1675 nm. Alternatively, the first wavelength is in a range from 635 nm to 640 nm and the third wavelength is in a range from 1530 nm to 1675 nm. In all of these alternatives, the sum of the reciprocals of the second and third wavelengths corresponds to the reciprocal of the first wavelength. Furthermore, the second wavelength is smaller than the third wavelength Furthermore, the following applies for the angle φ:

$$ϕ = {ϕ}_{0} + \frac{\partial ϕ}{\partial λ} Δλ + \frac{\partial ϕ}{\partial λ} \frac{\partial λ}{\partial T} Δ T , with T = 80 °C + Δ T ; \\ λ = 1064 nm + Δλ ; {ϕ}_{0} = 33 ° \pm 1 ° ; \frac{\partial ϕ}{\partial λ} = - 0.9 ° / nm \pm 0.1 ° / nm ; \\ and \frac{\partial λ}{\partial T} = 0.05 nm / °C \pm 0.015 nm / °C .$$

The first of the alternatives is particularly suitable for converting wavelengths of defect qubits into the telecom frequency band. The second of the alternatives is particularly suitable for converting wavelengths of nitrogen defect qubits into the telecom frequency band. The third of the alternatives is particularly suitable for converting wavelengths of nitrogen defect qubits into the C, L or U band by means of an Nd laser.

According to embodiments, the device is configured to convert single photons of the input radiation into photons of the output radiation while preserving quantum information. For example, the rate of noise photons, i.e. photons of the third wavelength which do not result from a conversion of a photon of the input radiation in a three-wave mixture, normalized to the conversion efficiency of input radiation to output radiation and to the bandwidth of the output radiation is at most 6.12 Hz/pm/%.

Further embodiments of the present invention provide a method for frequency conversion of electromagnetic radiation. The method comprises superimposing electromagnetic input radiation of a first wavelength with electromagnetic driving radiation of a second wavelength along a propagation path in a non-linear medium to generate electromagnetic output radiation of a third wavelength. The second wavelength is longer than the first wavelength. Furthermore, superpositioning takes place in the non-linear medium such that the driving radiation propagates freely in the non-linear medium.

### BRIEF DESCRIPTION OF THE DRAWINGS

Embodiments of the invention are described below referring to the appended drawings, in which:

FIG. 1 illustrates a device for frequency conversion of electromagnetic radiation according to an embodiment;

FIG. 2 illustrates a beam path in the non-linear medium according to embodiments;

FIG. 3 illustrates an example of the non-linear medium with angled facets;

FIG. 4 illustrates an example of an orientation of the propagation path relative to crystallographic axes of the non-linear medium;

FIG. 5 illustrates an example of a non-linear medium with periodically changing polarity;

FIG. 6 illustrates an example of the device with a resonator;

FIGS. 7A-7C illustrate examples of the resonator;

FIGS. 8A-8C illustrate examples of beam paths in the resonator;

FIG. 9 illustrates an example of a device for frequency conversion of electromagnetic radiation with reuse of the driving radiation; and

FIG. 10 shows a flow chart of a method of frequency conversion according to an embodiment.

### DETAILED DESCRIPTION OF THE INVENTION

In the following, embodiments of the present invention will be described in detail using the accompanying descriptions. In the following description, many details are described in order to provide a more thorough explanation of embodiments of the invention. However, it will be apparent to those skilled in the art that other embodiments can be implemented without these specific details. Features of the different embodiments described may be combined with one another, unless features of a corresponding combination are mutually exclusive or such a combination is explicitly excluded.

It is to be noted that the same or similar elements or elements having the same functionality may be provided with the same or similar reference numerals or be termed the same, wherein a repeated description of elements provided with the same or similar reference numerals or termed the same is typically omitted. Descriptions of elements having the same or similar reference numerals or termed the same are interchangeable.

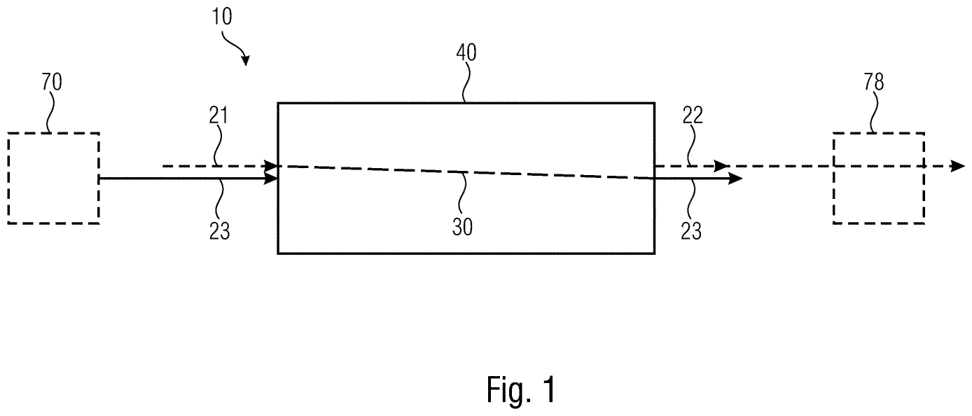

FIG. 1 illustrates a device 10 for frequency conversion of electromagnetic radiation according to an embodiment. For example, the device 10 can function as a quantum frequency converter. The device 10 has a non-linear medium 40. The device 10 is configured to superimpose electromagnetic input radiation 21 in the non-linear medium 40 with electromagnetic driving radiation 23 along a propagation path 30. For example, the device 10 may provide the driving radiation 23 on the propagation path 30 in the non-linear medium 40. Further, the device 10 may be configured to provide the input radiation 21 on the propagation path 30 in the non-linear medium 40. The input radiation 21 has a first wavelength λ₁. The driving radiation has a second wavelength λ₂ which is greater than the first wavelength. By superimposing the input radiation 21 and the driving radiation 23, the output radiation 22 can be generated in the non-linear medium. The output radiation 22 has a third wavelength λ₃. The non-linear medium 40 is configured for free propagation of the driving radiation 23, and optionally also of the input radiation 21 and the output radiation 22.

An intensity of the input radiation 21 may be lower than an intensity of the driving radiation 23. For example, the input radiation 21 may be photons generated using quantum emitters. For example, the input radiation may be single photons, i.e. the input radiation may have a rate of less than 100,000 Hz. A power of the input radiation 21 can therefore be smaller by at least a factor of 10⁸ or a factor of 10¹⁰ than a power of the driving radiation 23.

For example, generating the output radiation 22 based on the input radiation 21 can be based on a non-linear conversion process, e.g. of second order, in particular three-wave mixing. Accordingly, a relation between the wavelengths λ₁, λ₂ and λ₃ can result from the conservation of energy. By superimposing the input radiation 21 with the driving radiation 30, a photon of the input radiation 21 can be converted into a photon of the output radiation 22 with high probability, i.e. with high conversion efficiency. Thus, the participation of a photon of the driving radiation 30 can ensure the conservation of energy in the conversion process. The probability of this three-wave mixing increases with an increasing density of photons of the driving radiation 30. Accordingly, the device 10 may be configured to focus the input radiation 21 and the driving radiation 23 at a common point on the propagation path 30 in the non-linear medium 40. For this purpose, the device 10 may, for example, have focusing optical elements, for example lenses, which may, for example, be arranged in an optical path of the driving radiation 23 and the input radiation 21 before entering the non-linear medium 40. Accordingly, the device 10 can have optical elements for collimating the driving radiation 23 and the output radiation 22 in the beam path after the non-linear medium.

According to embodiments, the first wavelength can be in a range from 190 nm to 1260 nm. Furthermore, the third wavelength can be in a range from 1260 nm to 1675 nm. Here, but also in other embodiments, the sum of the reciprocals of the second and third wavelengths may correspond to the reciprocal of the first wavelength. The wavelength of the driving radiation 23 can therefore be adapted to the first wavelength λ₁ and the third wavelength λ₃ such that the requirement of energy conservation in the conversion process is fulfilled.

According to some embodiments, the second wavelength is smaller than the third wavelength. Thus, according to these embodiments, the second wavelength is the middle wavelength in the three-wave mixing process of the input radiation, the output radiation and the driving radiation.

Examples of materials of the non-linear medium 40 are beta-barium borate (BBO), beta BaB₂O₄, lithium niobate (LN), LiNbO₃ or MgO:LiNbO₃, lithium tantalate LiTaO₃ or MgO:LiTaO₃, potassium titanyl arsenate (KTA), KTiOAsO₄, potassium titanyl phosphate (KTP), KTiOPO₄, lithium triborate (LBO), LiB₃O₅, and bismuth triborate (BiBO), BiB₃O₆.

According to embodiments in which the material of the non-linear medium is one of those mentioned above, the third wavelength is in a range from 1260 nm to 1675 nm. Furthermore, the first wavelength is in a range from 200 nm to half the third wavelength. In other words, the first wavelength is greater than 350 nm and the second wavelength is smaller than the third wavelength. In embodiments, the first wavelength is in a range from 600 nm to 650 nm. In particular, the first wavelength is advantageously above the short-wave band edge of the material of the non-linear medium. In KTA, KTP, at 350 nm, in beta BaB₂O₄ at 185 nm, in LiTaO₃ at 280 nm, in LiNbO₃ at 330 nm, in BiBO at 286 nm, and in LBO at 160 nm.

According to embodiments, the non-linear medium has a uniform polarity along the propagation path, i.e., for example, a uniform second-order electrical susceptibility. The non-linear medium may, for example, have a continuous crystal structure.

Optionally, the device may further comprise a filter arrangement 78, which is arranged in an optical path of the output radiation 22. The filter arrangement is configured to transmit the output radiation 22 and to suppress the driving radiation 23. This allows the output radiation to be separated from the driving radiation in order to use the output radiation further, for example to transmit it.

According to embodiments, the filter arrangement is configured to attenuate the driving radiation by at least a factor of 10⁶ or by a factor of 10⁸. Strong suppression of the driving radiation allows low-noise provision of the output radiation.

Optionally, the device may further comprise a polarization filter arrangement which is arranged in an optical path of the output radiation 22, for example as shown in FIG. 1 for the filter arrangement 78. The polarization filter arrangement may be implemented alternatively or additionally to the filter arrangement 78, or may be combined with it. The polarization filter arrangement suppresses electromagnetic radiation with a polarization perpendicular to a polarization direction of the output radiation. For example, the output radiation can be linearly polarized. Accordingly, the polarization filter arrangement can be arranged such that it transmits electromagnetic radiation with a polarization direction parallel to the polarization direction of the output radiation, and suppresses electromagnetic radiation with a polarization direction perpendicular to the polarization direction of the output radiation. For example, the polarization filter arrangement may be implemented in embodiments in which the non-linear medium comprises or consists of KTA.

It has been found that conversion or emission processes which generate noise photons which are polarized perpendicular to the output radiation can occur in non-linear media, especially in KTA. These can be suppressed by a polarization filter in the beam path of the output radiation, thus improving the signal-to-noise ratio of the output radiation.

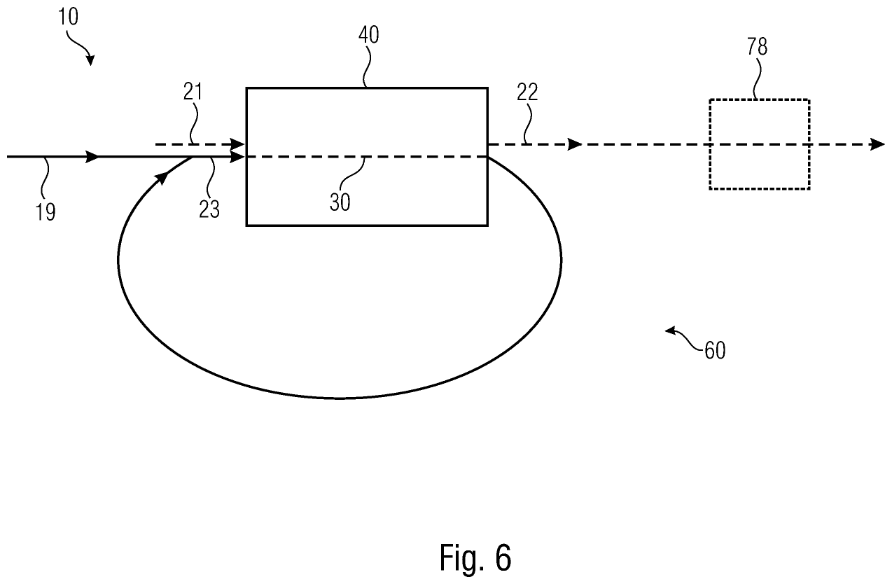

Furthermore, the device 10 may optionally comprise a radiation source 70, e.g. a laser, which provides electromagnetic radiation to provide the driving radiation 23. To this end, the electromagnetic radiation of the radiation source 70 may be coupled into a resonator, as described with respect to FIG. 6. In alternative embodiments, the radiation source 70 may provide the driving radiation 23, i.e. at full intensity, without the propagation path 30 in the non-linear medium 40 having to be in a resonator or cavity. In both cases, an intensity of the driving radiation 23 with a high power, e.g. more than 100 W, with a high beam quality, e.g. M²<1.5, and a narrow spectral bandwidth, e.g. <100 MHz, can be provided. The use of a resonator allows the output power of the radiation source to be kept low, which saves costs. In other words, superelevating the resonator reduces the used laser power to the same extent, and thus the system price. The use of a radiation source which provides the driving radiation 23 directly, without an external resonator, on the other hand, allows the device to be implemented without a resonator, and therefore more simply.

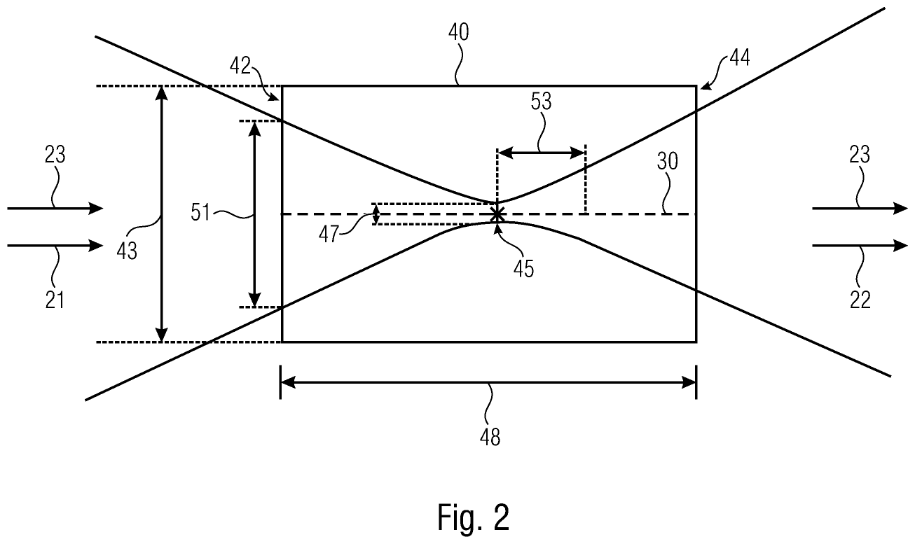

Free propagation can, for example, be understood to be propagation without waveguiding. For example, this may mean that the non-linear medium does not have a waveguide structure and/or that the non-linear medium is not part of such a structure. Examples of a propagation of the driving radiation 23 in the non-linear medium are described below with regard to FIG. 2, wherein the properties of the optical paths described therein can optionally also apply to the input radiation 21 and the output radiation 22.

FIG. 2 illustrates an optical path of the driving radiation 23, the input radiation 21 and the output radiation 22 according to an embodiment. As shown in FIG. 2, the driving radiation 23 and the input radiation 21 can enter the non-linear medium 40 through an inlet facet 42. The driving radiation 23 and the input radiation 21 may be focused on a focal point 45, which denotes a position along the propagation path 30. The driving radiation 23 and the output radiation 22 may in turn exit the non-linear medium 40 at an outlet facet 44. The inlet facet 42 can have an aperture 43, which can be circular or oval or rectangular, for example. In examples, the non-linear medium 40 is cylindrical or cuboid so that an aperture of the outlet facet 44 is equal to an aperture of the inlet facet 42. In other examples, however, an aperture of the outlet facet 44 can also have a different size from the aperture of the inlet facet 42. In the following description, a circular beam cross-section of the driving radiation 23 and the input radiation 21 is assumed so that the size relations discussed apply to all spatial directions perpendicular to the propagation path 30. However, the beam cross-section is not necessarily circular, but can also be oval or have another shape, for example. The size relations discussed then apply to the consideration of a specific spatial direction perpendicular to the propagation path 30.

At the focal point 45, the driving radiation has a beam cross-section size 47, also referred to as 2*w₀, where w₀ can be the radius in the case of a circular beam cross-section. The beam cross-section 47 of the driving radiation 23 can be different from a beam cross-section of the input radiation 21 at the focal point 45, or identical to it. The smaller the beam cross-section 47, the higher the power density of the driving radiation 23 in the focal point 45, and the higher the probability of the conversion process can be. As shown in FIG. 2, the driving radiation 23 can diverge after passing through the focal point 45 and leave the non-linear medium through the outlet facet 44.

Accordingly, according to embodiments, free propagation of the driving field and/or the input radiation 21 takes place in the non-linear medium 40. There is no wave guiding.

In embodiments, a length 48 of the non-linear medium 40 along the direction of the propagation path 30 satisfies the following condition:

$$L \leq {z}_{R} * \sqrt{\frac{1}{3} {( \frac{D}{{w}_{0}} )}^{2} - 4}$$

Here, w₀ denotes the beam cross-section 47 of the driving radiation 23 and D the aperture 43 of the inlet facet 42 and/or the outlet facet 44. As can be seen from FIG. 2, such a length 48 of the non-linear medium 40 ensures that a beam diameter 51 at the inlet facet 42 or the outlet facet 44 is so small that it can pass the aperture 43 in an undiffracted manner. Driving radiation 23 propagating freely in the non-linear medium is therefore not reflected at an interface of the non-linear medium 40 which is different from the outlet facet 44 so that no waveguiding takes place. If the inlet facet and the outlet facet have apertures of different sizes, the aperture D can, for example, refer to the smaller aperture of an inlet aperture and an outlet aperture of the non-linear medium, or to an average value of the apertures of the inlet and outlet facets.

The intensity of focusing the driving radiation 23 on the focal point 45 or the divergence of the driving radiation 23 starting from the focal point 45, i.e. the opening angle of the driving radiation 23 seen upstream and downstream of the focal point, can be described approximately, for example, by means of the Rayleigh length 53. According to embodiments, the Rayleigh length 53 of the driving radiation 23 in the focal point 45 is at most the Rayleigh length which a Gaussian beam with the same wavelength and the same beam cross-section 47 would have in the focal point 45 as the driving radiation 23. This may apply from the focal point 45 along the beam direction and opposite the beam direction.

According to embodiments, the length 48 of the non-linear medium 40 is at least 2 mm. As can be seen from FIG. 2, the beam cross-section 51 increases with increasing distance from the focal point 45 due to the expansion of the beam starting from the focal point 45. A greater length of the non-linear medium 40 therefore allows a larger beam cross-section 51 on the inlet facet 42 and the outlet facet 44. With a constant power density at the focal point 45, a greater length 48 can therefore reduce the power density on the inlet facet 42 and the outlet facet 44. The surfaces of the non-linear medium can be particularly susceptible to destruction by high power densities. The power density on the inlet facet 42 and the outlet facet 44 can be kept sufficiently low by a length of the non-linear medium 40 of at least 2 mm.

For example, the diameter D of the aperture 43, or generally a size D of the aperture 43, is at least:

$$D \geq \sqrt{\frac{12 P}{π {I}_{D}}} ,$$

where P is the power of the driving field and I_{D} is the damage threshold. With P=100 W and the values for I_{D} (according to [25], thermal is dominant in the ns-pulse regime and in the regime of high reprates, which is why the damage thresholds are assumed to be transferable to the cw regime), in particular the aperture 43 can be configured as follows for the materials of the non-linear medium 40 mentioned below: BBO: D>=11.5 μm [26], LBO: D>=4 μm [27], KTA and KTP: D>=9 μm [28], LN: D>=18 μm [29], MgO:LN: D>=100 μm [30], LiTa: D>=13 μm [29], MgO:LiTa: D>=260 μm [31].

Furthermore, according to embodiments, the length 48 of the non-linear medium 40 is at most 60 mm. Due to the different wavelengths of the driving radiation, the input radiation and the output radiation, phase matching of the radiations loses accuracy with increasing distance. A length of less than 60 mm allows precise phase matching over the length of the non-linear medium.

According to embodiments, the aperture 43, for example at least the smaller of the apertures of the inlet facet and the outlet facet, is between 0.5 mm and 10 mm. As already mentioned, the beam cross-section does not necessarily have to be circular. Accordingly, the mentioned size range for the aperture in examples applies independently for each spatial direction perpendicular to the propagation path 30. For example, the size range mentioned can apply independently for both of two main axes of an oval aperture or for two edge lengths of a rectangular aperture.

In other words, the non-linear medium 40 can, according to embodiments, be configured in lengths between 2 mm and 60 mm in both cylindrical and oval, in particular circular, geometry, wherein a size range of 0.5 mm to 10 mm can be of advantage for the edge lengths of the aperture or the main axes of the aperture.

According to embodiments, a power density of the driving radiation 23 in the focus 45 is at least 2/π·10⁵ W/cm², or at least 2/π·10⁶ W/cm². The power density can, for example, refer to the time-averaged power per area of the beam cross-section perpendicular to the propagation path 30 in the focal point 45. The limits of the beam cross-section can, for example, be defined by the line along which the intensity has dropped to 1/e² of the intensity in the beam center, i.e. on the propagation path 30. The latter can also apply to the previous considerations.

According to embodiments, the focus radius w₀ and the power of the driving radiation 23, P_{drive}, are thus selected such that at least one of the following conditions is fulfilled:

$${P}_{drive} > 2 \cdot {10}^{5} W / {cm}^{2} \cdot {( {w}_{0}^{drive} )}^{2} or {P}_{drive} > 2 \cdot {10}^{6} W / {cm}^{2} \cdot {( {w}_{0}^{drive} )}^{2}$$

According to embodiments, the device 10 is configured to provide the driving radiation 23 in continuous wave mode. This ensures that an incoming photon of the input radiation 21 can be converted into a photon of the output radiation 22 at any time.

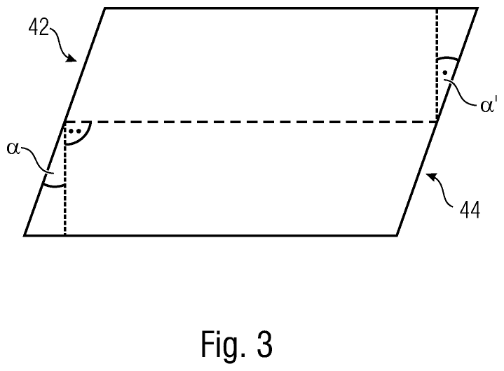

FIG. 3 illustrates an embodiment of the non-linear medium 40. According to the embodiment shown in FIG. 3, the inlet facet 42 of the non-linear medium 40 encloses an angle α in a range from 0° to 10° with a plane perpendicular to the propagation path 30. Furthermore, the outlet facet 44 of the non-linear medium 40 encloses an angle α′ in a range from 0° to 10° with a plane perpendicular to the propagation path 30. In examples, the magnitude of the angle α may be the same as the magnitude of the angle α′. The inlet facet 42 and the outlet facet can therefore be parallel to each other in this case. In particular, according to embodiments, the angle α and the angle α′ can be greater than 0°. In this case, electromagnetic radiation which is reflected by the inlet facet 42 or the outlet facet 44 is reflected such that it leaves an optical path along which the driving radiation 23 propagates.

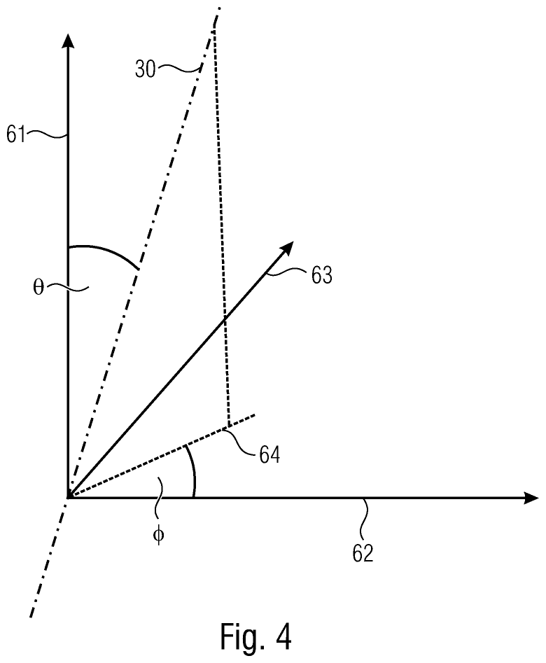

FIG. 4 illustrates an orientation of the propagation path 30 with respect to crystallographic axes of the non-linear medium according to embodiments. For example, the non-linear medium 40 comprises a material having a crystal structure or consists of a material having a crystal structure. The crystal structure can be described by means of crystallographic axes. The material of the non-linear medium 40 may be an optically anisotropic medium. In examples, the non-linear medium may have one (i.e. exactly one) optical axis. In further examples, the non-linear medium may have two optical axes. Examples of materials of the non-linear medium 40 which have one optical axis include beta barium borate (BBO), beta BaB₂O₄, lithium niobate (LN), LiNbO₃ or MgO:LiNbO₃, and lithium tantalate, LiTaO₃ (LT) or MgO:LiTaO₃ (MLT). Examples of materials of the non-linear medium 40 with two optical axes for the non-linear medium are potassium titanyl arsenate (KTA), KTiOAsO₄, potassium titanyl phosphate (KTP), KTiOPO₄, lithium triborate (LBO), LiB₃O₅, and bismuth triborate (BiBO), BiB₃O₆.

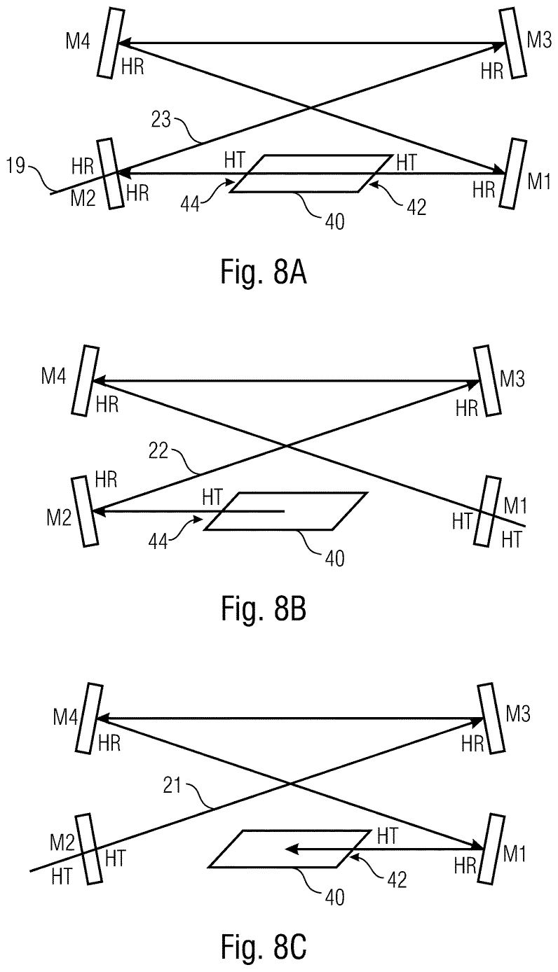

According to embodiments, the non-linear medium 40 is configured such that the propagation path 30 has a specific orientation with respect to the crystallographic axes of the material of the non-linear medium. With these specific orientations, high efficiency of the conversion process can be achieved, in particular efficiency in the order of quantum efficiency. Due to the particularly high efficiency when using these specific orientations, a lower laser power can also be used, resulting in a lower risk of destruction of the optical components and a lower thermal energy input into the NLM. This can, for example, reduce the stability of cavity control, as described with regard to FIG. 8.

According to embodiments in which the material of the non-linear medium 40 has one, i.e. exactly one, optical axis, e.g. BBO, LT, MLT or LN, the non-linear medium is configured such that the optical axis encloses an angle θ with the propagation path 30. In these cases, the optical axis coincides with a first crystallographic axis 61 of the non-linear medium 40. The first crystallographic axis is referred to as the z-axis or c-axis in these materials, for example.

In embodiments in which the material of the non-linear medium 40 has two optical axes, for example in examples in which the material of the non-linear medium 40 is KTA, KTP, LBO or BiBO, the non-linear medium 40 is configured such that a first crystallographic axis 61 of the non-linear medium 40 encloses an angle θ with the propagation path 40 and a projection 64 of the propagation path 30 into a plane spanned by a second crystallographic axis 62 (e.g. x-axis) and a third crystallographic axis 63 (e.g. y-axis) encloses an angle φ with the second crystallographic axis 62. The angle φ can, for example, be measured starting from the second crystallographic axis in the direction of the third crystallographic axis. The assignment of the crystallographic axes of the non-linear medium 40 to the first, second and third crystallographic axes is such that the refractive index along the first crystallographic axis 61 (z) is greater than the refractive index along the third crystallographic axis 63 (y), and the refractive index along the third crystallographic axis is greater than the refractive index along the second crystallographic axis 62 (x).

Since the refractive index can be temperature-dependent, the choice of angles θ and φ can be related to a temperature T of the non-linear medium 40 during operation. This may in turn depend on the power of the driving field 23. In embodiments, the device 10 may be configured to maintain the temperature T at a temperature T during operation. According to embodiments, the operating temperature of the non-linear medium 40 during operation of the device 10 is in a range between 0 °C and 200 °C.

According to embodiments, the angle θ, the angle, the temperature T of the non-linear medium 40 during operation of the device 10 are selected in dependence on the material of the non-linear medium 40 such that the following system of equations is satisfied. The first system of equations applies to the materials with one optical axis and the second system of equations applies to the materials with two optical axes. Here, n denotes the refractive index in dependence on the specified parameters.

### System of Equations 1:

$$\frac{1}{{λ}_{1}} = \frac{1}{{λ}_{2}} + \frac{1}{{λ}_{3}}$$

$$\frac{n ( {λ}_{1} , θ , T )}{{λ}_{1}} = \frac{n ( {λ}_{2} , θ , T )}{{λ}_{2}} + \frac{n ( {λ}_{3} , θ , T )}{{λ}_{3}} ,$$

### System of Equations 2:

$$\frac{1}{{λ}_{1}} = \frac{1}{{λ}_{2}} + \frac{1}{{λ}_{3}}$$

$$\frac{n ( {λ}_{1} , θ , ϕ , T )}{{λ}_{1}} = \frac{n ( {λ}_{2} , θ , ϕ , T )}{{λ}_{2}} + \frac{n ( {λ}_{3} , θ , ϕ , T )}{{λ}_{3}} ,$$

According to embodiments, the angle θ or the two angles θ and φ are selected as described in reference [14]. Furthermore, according to these embodiments, the refractive index n in dependence on the temperature T is taken from the following references to solve the above systems of equations: for BBO, references and [16]; for LN, references and [18]; for MgO:LiNbO₃, reference [19]; for KTP, references [20], and [25]; for LBO, reference [22]; for BiBO, reference [23]; for KTA, for example, for values of the first wavelength of λ₁=313 nm or λ₁=422 nm, reference [24].

According to embodiments in which the non-linear medium 40 is KTA, the angle θ is 90° and the following applies to the angle φ:

$$ϕ = {ϕ}_{0} + \frac{\partial ϕ}{\partial λ} Δλ + \frac{\partial ϕ}{\partial λ} \frac{\partial λ}{\partial T} Δ T$$

Here, T=80 °C+ΔT; λ=1064 nm+Δλ; and φ₀=33°±1°. Furthermore, the sum of the reciprocals of the second and third wavelengths corresponds to the reciprocal of the first wavelength, and the second wavelength is smaller than the third wavelength. According to a first alternative, the first wavelength is in a range from 350 nm to 840 nm, and the third wavelength is in a range from 1260 nm to 1675 nm. The following applies to the above equation:

$$\frac{\partial ϕ}{\partial λ} = - 0.9 ° / nm \pm 0.3 ° / nm ; and \frac{\partial λ}{\partial T} = 0.05 nm / °C \pm 0.025 nm / °C .$$

According to a second alternative, the first wavelength is in a range from 600 nm to 700 nm and the third wavelength is in a range from 1260 nm to 1675 nm. According to a third alternative, the first wavelength is in a range from 635 nm to 640 nm and the third wavelength is in a range from 1260 nm to 1675 nm. According to a fourth alternative, the first wavelength is in a range from 635 nm to 640 nm and the third wavelength is in a range from 1530 nm to 1675 nm. For the second to fourth alternatives, for the above equation:

$$\frac{\partial ϕ}{\partial λ} = - 0.9 ° / nm \pm 0.1 ° / nm and \frac{\partial λ}{\partial T} = 0.05 nm / °C \pm 0.015 nm / °C .$$

According to embodiments, a combination of the first wavelength λ₁, the material of the non-linear medium 40, the angle θ, in the case of a non-linear medium with two optical axes, the angle φ, and the second wavelength λ2 of the driving radiation 23 corresponds to one of the combinations given in Tables 1 to 3. Table 1 relates to embodiments in which the first wavelength is 313 nm, Table 2 relates to embodiments in which the first wavelength is 422 nm, and Table 3 relates to embodiments in which the first wavelength is 637 nm. For each of the specified combinations, the second wavelength is a wavelength from the respective specified range. For example, the second wavelength may be selected according to a desired wavelength of the output radiation 22. In examples, the first wavelength may be from a range of +/−2 nm around the specified value. The angles θ and φ indicated in Tables 1 to 3 each denote an angular range of +/−5° around the respective specified value. This means that the angle θ and the angle φ can each be an angle from a range of +/−5° and the value specified for the respective combination.

According to further embodiments, a combination of the first wavelength, the material of the non-linear medium 40, the angle θ, in the case of a non-linear medium with two optical axes, the angle φ, the second wavelength λ₂ and additionally the temperature T corresponds to a combination indicated in Tables 1 to 3.

For example, the combinations indicated in Tables 1 to 3 can be used to convert electromagnetic radiation from quantum emitters emitting at the respective first wavelength λ₁, into a spectral range relevant for telecommunications. For example, quantum emitters, which are implemented by means of ⁹Be+ ion traps, see reference [8], emit in a spectral range around 313 nm. In this case, conversion can be performed using a driving field 23 at a wavelength between 388 nm and 423 nm in the telecom frequency range from 1260 nm to 1675 nm. In alternative embodiments, the first wavelength is 422 nm, which can be converted into the telecom frequency range mentioned using a driving field at a wavelength of 570 nm to 630 nm. In yet other embodiments, the first wavelength is 637 nm, for example when implementing quantum emitters using electron spin qubits in nitrogen defect centers in diamond, see reference [9]. Using a driving field 23 at a wavelength between 1050 nm and 1275 nm, this wavelength can be converted to the telecom frequency range mentioned.

TABLE 1
λ₁ = 313 nm

| NLM | BBO | BiBO | BiBO | BiBO | BiBO | BiBO |
|---|---|---|---|---|---|---|
| θ/° | 35 | 60 | 70 | 80 | 90 | 140 |
| φ/° | — | 0 | 0 | 0 | 0 | 90 |
| T/°C | 0-200 | 0-200 | 0-200 | 38-200 | 119-200 | 0-200 |
| λ₂/nm | 388-423 | 388-423 | 388-423 | 416-423 | 418-423 | 388-423 |
| NLM | BiBO | LBO | LBO | LBO | LBO | LBO |
| θ/° | 150 | 5 | 15 | 25 | 35 | 45 |
| φ/° | 90 | 90 | 90 | 90 | 90 | 90 |
| T/°C | 0-180 | 0-116 | 0-200 | 0-200 | 0-6 | 6-200 |
| λ₂/nm | 388-403 | 388-399 | 388-404 | 389-413 | 413-423 | 398-423 |

| NLM | LBO | LBO | LBO | LBO |
|---|---|---|---|---|
| θ/° | 55 | 90 | 5 | 15 |
| φ/° | 90 | 37 | 0 | 0 |
| T/°C | 178-200 | 0-200 | 0-114 | 0-47 |
| λ₂/nm | 422-423 | 388-423 | 388-397 | 388-391 |

TABLE 2
λ₁ = 422

| NLM | BBO | BBO | BiBO | BiBO | BiBO | BiBO | BiBO | BiBO |
|---|---|---|---|---|---|---|---|---|
| θ/° | 29.9 | 50 | 49.5 | 59.5 | 157.8 | 90 | 90 | 90 |
| φ/° | — | — | 0 | 0 | 90 | 55 | 65 | 75 |
| T/°C | 0-200 | 0-200 | 0-200 | 0-200 | 0-200 | 0-131 | 0-189 | 0-200 |
| λ₂/nm | 570-630 | 570-630 | 570-630 | 597-630 | 570-630 | 604-630 | 587-630 | 577-630 |
| NLM | BiBO | KTA | KTA | KTA | KTA | KTA | KTA | KTA |
| θ/° | 90 | 81.6 | 90 | 90 | 90 | 90 | 90 | 90 |
| φ/° | 85 | 0 | 0 | 10 | 20 | 30 | 40 | 50 |
| T/°C | 0-200 | 0-142 | 0-156 | 0-156 | 0-200 | 0-200 | 0-200 | 0-200 |
| λ₂/nm | 573-622 | 570-582 | 570-583 | 570-585 | 570-589 | 574-589 | 580-600 | 587-606 |
| NLM | KTA | KTA | KTA | KTA | KTA | KTA | KTA | KTA |
| θ/° | 90 | 90 | 90 | 90 | 65 | 75 | 85 | 68.4 |
| φ/° | 60 | 70 | 80 | 90 | 90 | 90 | 90 | 90 |
| T/°C | 0-200 | 0-200 | 0-200 | 0-195 | 0-200 | 0-200 | 0-200 | 0-200 |
| λ₂/nm | 595-612 | 602-616 | 607-618 | 610-619 | 570-601 | 583-611 | 603-619 | 570-598 |
| NLM | KTP | KTP | KTP | KTP | KTP | KTP | KTP | KTP |
| θ/° | 75 | 85 | 60 | 70 | 90 | 90 | 90 | 90 |
| φ/° | 0 | 0 | 90 | 90 | 5 | 15 | 25 | 35 |
| T/°C | 0-200 | 0-200 | 0-200 | 0-200 | 0-200 | 0-200 | 0-200 | 0-200 |
| λ₂/nm | 570-595 | 592-604 | 570-608 | 608-630 | 601-608 | 603-614 | 607-618 | 615-627 |
| NLM | KTP | LBO | LBO | LBO | LBO | LBO | LBO | LBO |
| θ/° | 90 | 5 | 15 | 25 | 5 | 15 | 25 | 90 |
| φ/° | 45 | 90 | 90 | 90 | 0 | 0 | 0 | 19 |
| T/°C | 0-200 | 129-200 | 130-200 | 194-200 | 0-200 | 0-200 | 0-75 | 0-200 |
| λ₂/nm | 625-630 | 602-630 | 609-630 | 629-630 | 601-630 | 570-630 | 570-587 | 570-630 |

TABLE 3
λ₁ = 637 nm

| NLM | BBO | BBO | BiBO | BiBO | BiBO | KTA | KTA | KTA |
|---|---|---|---|---|---|---|---|---|
| θ/° | 24 | 34 | 5 | 40 | 50.4 | 90 | 90 | 90 |
| φ/° | — | — | 0 | 0 | 0 | 5 | 15 | 25 |
| T/°C | 0-200 | 0-200 | 0-200 | 0-200 | 0-200 | 0-200 | 0-200 | 0-200 |
| λ₂/nm | 1050-1275 | 1050-1275 | 1050-1275 | 1050-1275 | 1050-1275 | 1080-1097 | 1072-1093 | 1061-1084 |
| NLM | KTA | KTA | KTA | KTA | KTA | KTA | KTA | KTA |
| θ/° | 90 | 90 | 55 | 65 | 75 | 85 | 50 | 60 |
| φ/° | 35 | 45 | 0 | 0 | 0 | 0 | 90 | 90 |
| T/°C | 0-200 | 0-200 | 0-200 | 0-200 | 0-200 | 0-200 | 0-200 | 0-200 |
| λ₂/nm | 1050-1070 | 1034-1054 | 1060-1160 | 1143-1287 | 1113-1233 | 1073-1115 | 1038-1202 | 1143-1275 |
| NLM | KTA | KTP | KTP | KTP | KTP | KTP | KTP | LBO |
| θ/° | 70 | 57 | 67 | 77 | 48 | 58 | 68 | 5 |
| φ/° | 90 | 0 | 0 | 0 | 90 | 90 | 90 | 90 |
| T/°C | 0-200 | 0-200 | 0-200 | 0-200 | 0-200 | 0-200 | 0-200 | 0-200 |
| λ₂/nm | 1038-1152 | 1050-1275 | 1091-1275 | 1050-1100 | 1050-1275 | 1056-1244 | 1050-1056 | 1137-1275 |
| NLM | LBO | LBO | LBO | LBO | LBO | LBO | LBO | LBO |
| θ/° | 15 | 25 | 35 | 45 | 55 | 5 | 15 | 25 |
| φ/° | 90 | 90 | 90 | 90 | 90 | 0 | 0 | 0 |
| T/°C | 0-144 | 0-200 | 0-200 | 0-200 | 79-200 | 0-200 | 0-200 | 0-45 |
| λ₂/nm | 1189-1275 | 1134-1275 | 1133-1237 | 1050-1151 | 1050-1085 | 1080-1275 | 1050-1244 | 1050-1079 |

| NLM | LBO | LBO | LBO | LN |
|---|---|---|---|---|
| θ/° | 75 | 85 | 90 | 58 |
| φ/° | 0 | 0 | 5 | — |
| T/°C | 152-200 | 1-167 | 0-18 | 0-200 |
| λ₂/nm | 1050-1275 | 1050-1275 | 1050-1275 | 1050-1275 |

Alternatively, the conversion process can be realized outside the specified angular ranges, which can also achieve a low noise rate. In this case, a higher power of the driving field can be used to achieve a comparable conversion efficiency. This can be advantageously implemented by means of pump recycling, for example, see FIG. 8.

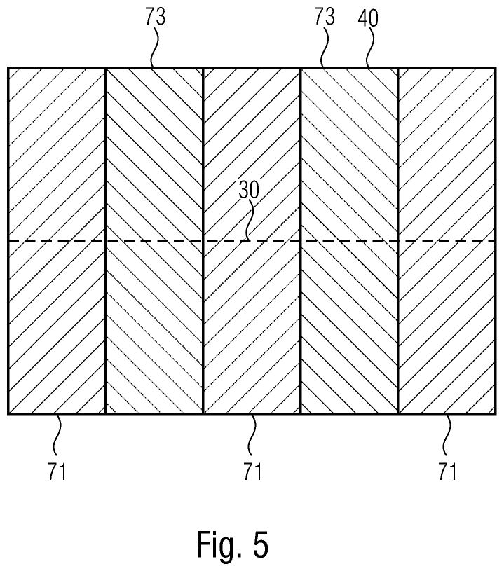

FIG. 5 illustrates a further embodiment of the non-linear medium 40, according to which the second order electrical susceptibility of the non-linear medium 40 has a periodically changing sign along the propagation path 30. According to these embodiments, the NLM 40 thus has a periodically changing polarity. For example, in FIG. 5, first regions 71 have a first polarity and second regions 73 have a second polarity.

According to embodiments with a periodically poled non-linear medium, the angle θ described with reference to FIG. 4 can be 90°. In examples, the angle φ can be chosen as desired. In other words, propagation can take place in the direction in which the effective non-linearity d_{eff} is at a maximum.

According to embodiments, a combination of the material of the non-linear medium 40 and a period γ of the periodically alternating polarity is one of those listed in Tables 4, 5 or 6. Table 4, for example, refers to a value for the first wavelength λ₁ of 422 nm and Table 5, for example, refers to a value for the first wavelength λ₁ of 637 nm, and Table 6, for example, refers to a value for the first wavelength λ₁ of 313 nm.

TABLE 4

| NLM | KTA | KTP | LN | LT and MLT |
|---|---|---|---|---|
| γ/μm | 4 to 5 | 4.8 to 5.5 | 3 to 4.5 | 3.9 to 4.8 |

TABLE 5

| | KTA | KTP | LN | LT and MLT |
|---|---|---|---|---|
| γ/μm | 14.5 to 15.5 | 15 to 16.5 | 11.5 to 12.5 | 12.7 to 13.9 |

TABLE 6

| NLM | LT/MLT |
|---|---|
| γ/μm | 1.4 to 1.9 |

In other words, the frequency conversion of photons in the infrared spectral range from 1260 nm to 1675 nm, which is relevant for telecommunications, can be realized according to embodiments of the present invention by a second-order non-linear conversion process (three-wave mixing) in a medium which does not contain a waveguide structure. Both periodically poled and un-poled (or uniformly poled) bulk crystals, i.e. crystals without waveguide structure, can be used.

FIG. 6 illustrates an example of the device 10, according to which the device 10 further comprises a resonator 60 which is resonant for the second wavelength λ₂. For example, the length of an optical path of the resonator 60 corresponds to an integer multiple of the second wavelength. The propagation path 30 in the non-linear medium 40 is arranged in the resonator 60, for example in an optical path of the resonator 60, in order to provide the driving radiation 23 along the propagation path 30.

The propagation path 30 can therefore be part of an optical path of the resonator 60. For example, the resonator 60 is configured as a ring resonator, in the resonator 60 resonator input radiation 19 coupled into the resonator can be superimposed on itself several times so that the power of the driving radiation 23 in the resonator 60 can be a multiple of the power of the resonator input radiation 19. In other words, the driving radiation, also known as the driving field, can be generated by the resonant superelevation of a lower-power laser beam 19 in a cavity, i.e. the resonator. The representation of the resonator 60 in FIG. 6 is to be understood to be schematic. For example, the resonator input radiation 19 can be provided by the radiation source 70.

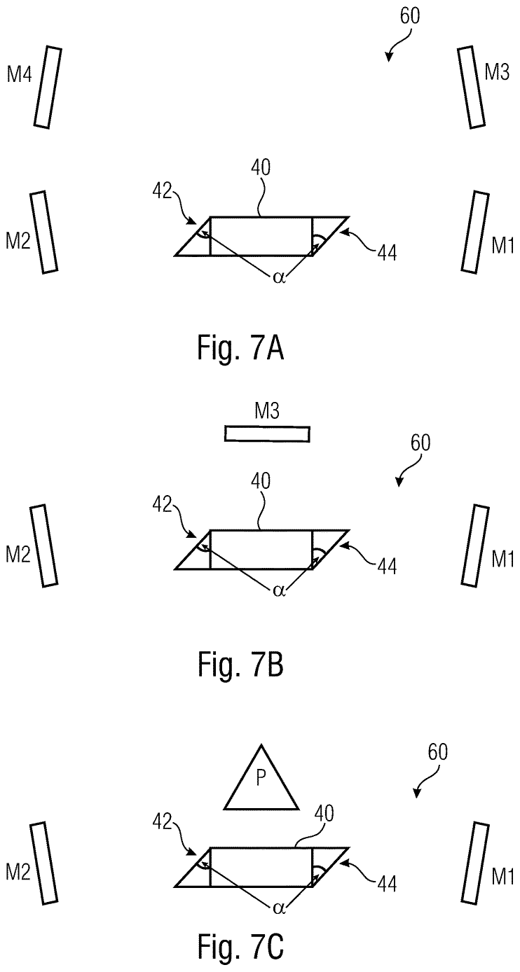

FIG. 7 illustrates examples of the resonator 60 as they may be implemented in embodiments of the device 10. FIG. 7a illustrates an example of the resonator 60 as a ring resonator with four mirrors M1-M4. FIG. 7b illustrates an example of the resonator 60 as a ring resonator with three mirrors M1-M3. FIG. 7c illustrates an example of the resonator 60 as a ring resonator with two mirrors M1 and M2 and a prism P.

In further embodiments, the resonator 60 can be realized by means of a ring resonator within the non-linear medium 40. In further embodiments, the resonator 60 is implemented as a resonator as used in so-called “whispering-gallery lasers”, see reference [10], or non-polar ring oscillators, see reference [11].

According to embodiments, the resonance condition of the resonator 60 is fulfilled for the driving radiation 23, but not for the input radiation 21 and the output radiation 22. This means, for example, that the resonator 60 is resonant for the wavelength of the driving radiation 23 and is not resonant for the wavelengths λ₁ and λ₃ of the input radiation 21 and the output radiation 22. In examples, the resonance condition of the resonator 60 is only fulfilled for the driving field 23.

According to embodiments, the mirrors of the resonators 60 shown in FIG. 7 are coated with mono- or dichroic highly reflective coating systems. All of the optics elements acting as resonator mirrors, i.e. the mirrors M1-M4 or M1-M3 or M1, M2 and P, may be implemented to be highly reflective (HR) for the driving field 23. Highly reflective can refer to a reflection coefficient of R_{HR}>99%.

The input radiation 21 can be coupled into the optical resonator 60 at one of the mirrors M #. Depending on which mirror this is implemented at, the input radiation is reflected at none, one or more of the optical elements M #, P acting as mirrors before entering the non-linear medium 40. Each of the optics elements at which the input radiation 21 is reflected before entering the non-linear medium 40 may, according to embodiments, be provided with an HR coating for the first wavelength λ₁. The mirror at which the input radiation 21 is coupled can also be provided with a highly transmissive (HT) coating, e.g. on both sides. In the highly transmissive case, the reflection coefficient R_{HT} can be <1% for the first wavelength. Similarly, according to embodiments, the output radiation 22 may be coupled out of the optical path of the resonator 60 at one of the mirrors. This mirror can be provided with an HT coating for the third wavelength λ₃ of the output radiation 22, for example on both sides. The output radiation 22 can be reflected at none, one or more of the optical elements acting as mirrors before exiting the optical path of the resonator 60. These can be coated with an HR coating for the third wavelength λ₃.

FIG. 8 illustrates examples of the beam paths of the driving radiation 23, the input radiation 21 and the output radiation 22 for the example of the resonator 60 with four mirrors shown in FIG. 7a. The beam paths shown in FIG. 8 represent the embodiments with reflection at the maximum possible number of mirrors for this implementation of the resonator 60. FIG. 8a illustrates an example of a beam path of the driving radiation 23. According to this embodiment, the four optics elements M1-M4 are coated with an HR coating on the side facing the resonator, i.e. the side on which the optical path of the resonator 60 is reflected. Furthermore, one of the optics elements, namely optics element M2, at which the resonator input radiation 19 is coupled into the resonator 60, is HR-coated on the side facing away from the resonator. Furthermore, the inlet facet 42 and the outlet facet 44 of the non-linear medium 40 can be HT-coated or AR-(anti-reflection) coated. FIG. 8b illustrates an example of a beam path for the output radiation 22. According to this example, the output radiation 22 is coupled out of the resonator 60 at the optics element M1 after the output radiation 22 has been reflected at the mirrors M2-M4. According to this example, the optics elements M2-M3 have HR coatings for the third wavelength λ₃ on the side facing the resonator 60. Furthermore, the optics element M1 has an HT coating on the side facing the resonator and on the side facing away from the resonator. Alternatively, the output radiation 22 can also be coupled out at the optics element M2, the optics element M3 or the optics element M4. In these cases, the HR coating for the third wavelength λ₃ can be omitted on the optics elements on which the output radiation 22 is not reflected. Furthermore, the outlet facet 44 of the non-linear medium 40 can be HT-coated for the third wavelength on the rear side in the beam direction. FIG. 8c illustrates an example of a beam path of the input radiation 21. According to this example, the input radiation 21 is coupled into the optics element M2, which has an HT coating for the first wavelength on the side facing the resonator and the side facing away from the resonator. In this case, the input radiation 21 is reflected at the optics elements M3, M4 and M1 before entering the non-linear medium 40. The optics elements at which the input radiation 21 is reflected have an HR coating for the first wavelength λ₁. Furthermore, the inlet facet 42 can have an HT coating for the first wavelength λ₁. In alternative examples, the input radiation 21 may be coupled in at M3 with subsequent reflection at M4 and M1, or the input radiation 21 may be coupled in at M4 with subsequent reflection at M1, or the input radiation 21 may be coupled in at M1. In these cases, the HR coating shown in FIG. 8c is omitted on the optics elements at which no reflection takes place. The optics elements at which the input radiation is coupled in can be HT-coated on both sides.

Irrespective of the specific implementation of the resonator 60, the device can be configured to control an optical path length of the resonator 60 to a multiple of the second wavelength.

In other words, the device 10 may be configured to actively maintain the resonance condition of the resonator 60 for the second wavelength. In other words, in order to maintain the resonance condition of the cavity in time, the optical path length can be controlled using a control loop to an integer multiple of the wavelength of the radiation to be superelevated. This can be implemented, for example, by attaching a cavity mirror to a piezoelectric element. This can, for example, be one of the mirrors in FIG. 7 or FIG. 8, advantageously one which is not HT-coated on the side facing away from the resonator. Alternatively, an optical element whose refractive index can be modulated by an electrical signal (e.g. acousto-optical modulator, Pockels cell, etc.) can be introduced into the beam path. To generate this electrical signal or a signal to control the piezoelectric element (control signal), a PID controller can be used, for example, which converts a so-called error signal into a control signal. The error signal can be generated in various ways (e.g. Pound-Drever-Hall method [12], Hänsch-Couillaud method [13], etc.).

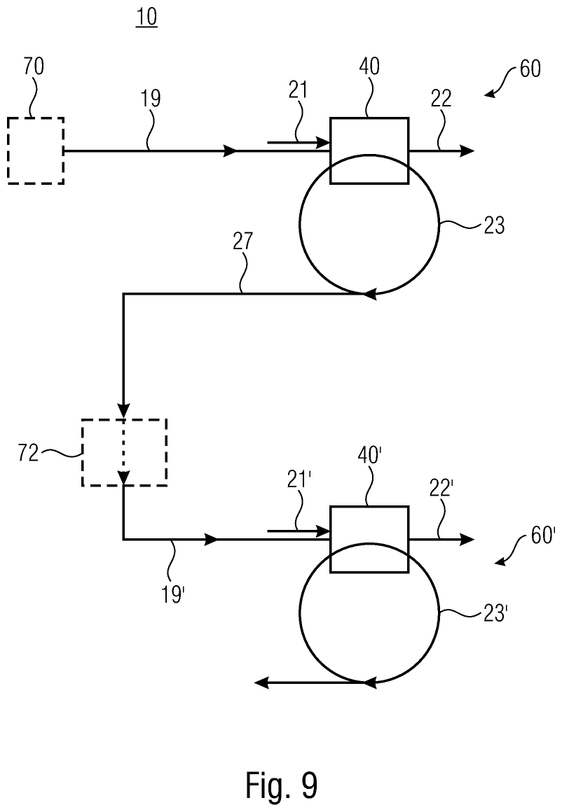

FIG. 9 illustrates a further example of the device 10. According to this embodiment, the device 10 also has a further resonator 60′. The further resonator 60′ is also resonant for the second wavelength λ₂ of the driving radiation 23. A further propagation path of a further non-linear medium 40′ is arranged in the resonator 60′. According to this embodiment, the device 10 is configured to superimpose further electromagnetic input radiation 21′ with further electromagnetic driving radiation 23′ of wavelength λ₂ along the propagation path of the further non-linear medium 40′ in order to generate further electromagnetic output radiation 22′. According to these embodiments, the device 10 is configured to use a portion 27 of the driving radiation 23 coupled out from the resonator 60 to provide the further driving radiation 23′ in the further resonator 60′.

The portion 27 of the driving radiation 23 coupled out from the resonator 60 can therefore be used to provide resonator input radiation 19′ of the further resonator 60′. For example, the further input radiation 21′ can have the first wavelength λ₁ of the input radiation 23 and the further output radiation 22′ can have the wavelength λ₃ of the output radiation 22. The resonator 60 and the NLM 40 can thus, for example, be part of a first frequency converter module, and the further resonator 60′ and the NLM 40′ can be part of a second frequency converter module. The device 10 can be extended by further frequency converter modules, wherein the portion of the driving radiation coupled out from one of the frequency converter modules can be used for one or more of the further frequency converter modules.

In other words, the driving radiation 27 transmitted through the superelevation cavity 60 can be utilized further according to embodiments. This can be implemented, for example, by introducing an optical system for collimation and focusing onto an optical fiber in the beam path of the transmitted radiation 23′. By means of the optical fiber, the transmitted radiation 23′ can be provided for a further converter, for example the converter formed by the further non-linear medium 40′ according to FIG. 8. In embodiments, the device 10 has further converters, i.e. further non-linear media 40′, in which respective driving radiation is provided by means of further resonators 60′. In other words, the arrangement shown in FIG. 8 can be cascaded.

Pump recycling as shown in FIG. 8 can be particularly advantageous in terms of operating and manufacturing costs of the device 10, especially for a plurality of frequency converter modules.

According to embodiments, the device 10 further comprises an amplifier 72. The amplifier 72 is configured to amplify the portion 27 of the driving radiation 23 coupled out from the resonator 60. Furthermore, the device 10 can feed the amplified driving radiation to the further resonator 60′. For example, the portion 27 of the driving radiation 23 can be amplified such that the driving radiation 23′ in the further resonator 60′ has the same power as the driving radiation 23 in the resonator 60.

In other words, the device 10 can be supplemented by a postamplifier 72 to achieve a constant input power 19 for different converters of a spatially extended transmission chain with multiple nodes, for example quantum processors, registers, repeaters.

For example, efficient coupling can be achieved by adjusting the length of the resonator to an integer multiple of the second wavelength. This ensures that beam components transmitted through the HR-coated mirror interfere constructively, while reflected beam components interfere destructively. With perfect control (and single-frequency radiation), 100% of the incident radiation passes through the HR mirror into the resonator. This is not dependent of the reflectivity. The superelevation achieved in the resonator 60 then results from how often the radiation in the resonator is superimposed on “itself”. The higher the reflectivity of the mirrors (or the lower the losses which the radiation experiences during a resonator revolution), the more often this occurs. The relation (without further losses) is: I/I_0=1/(1−R_1*R_2*R_3*R_4), where I/I_0 is the superelevation and R_i the reflectivities of the 4 resonator mirrors. For a ring resonator with HR-coated mirrors with R=99.5%, for example, this results in a superelevation of 50.

For example, the transmitted intensity 23′ then results from the transmittance of the respective mirrors. In the previous example, a portion of 0.5% is transmitted at each mirror. Multiplied by the power circulating in the resonator, it follows that 0.5%*50*1_0=0.25*1_0 is transmitted at each mirror. With perfect control and without losses in the resonator, 100% of the intensity of the radiation 19 is therefore transmitted into the resonator and also out of it again. In embodiments of the present invention, pump recycling is possible particularly efficiently because no losses of the resonant radiation field occur due to the conversion process, since a shorter wavelength photon at the input wavelength is converted into a photon of the driving radiation and a photon of the output wavelength.

The resonator input radiation 19 of the device 10 according to FIG. 6, FIG. 8 or FIG. 8 can thus be provided in examples by a radiation source 70, for example a laser. Alternatively, the resonator input radiation 19 can be provided by an amplifier. The resonator input radiation 19 is advantageously narrowband and can be linearly polarized.

It is to be noted that the further use of the driving radiation 23 described with regard to FIG. 9, the “pump recycling”, is not limited to embodiments with a resonator, but can also be implemented in embodiments in which the driving radiation 23 can be provided as described with regard to FIG. 1 without the propagation path 30 being arranged in a resonator. For this purpose, the driving radiation 23 can, for example, be provided as driving radiation 23′ after passing through the non-linear medium 40, or optionally be amplified by means of the amplifier 72 before being provided as driving radiation 23″.

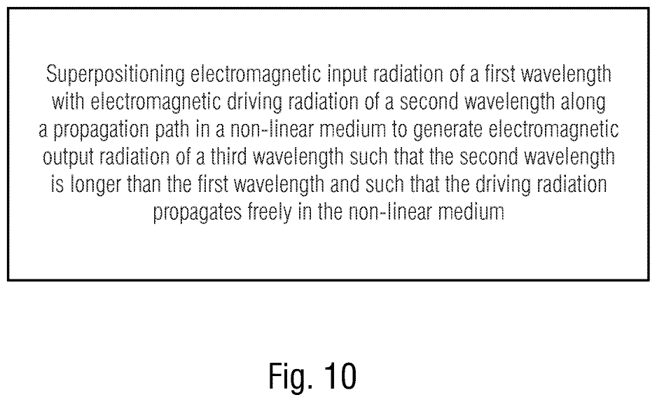

FIG. 10 shows a flow diagram of a method 100 according to an embodiment example. The method 100 comprises superimposing electromagnetic input radiation 21 of a first wavelength λ₁ with electromagnetic driving radiation 23 of a second wavelength λ₂ along a propagation path 30 in a non-linear medium 40 to generate electromagnetic output radiation of a third wavelength λ₃ such that the second wavelength λ₂ is longer than the first wavelength, and such that a power density of the driving radiation 23 in a focus 45 of the driving radiation 23 in the non-linear medium 40 is at least 2/π·10⁵ W/cm² or at least 2/π·10⁶ W/cm².

Embodiments of the invention can be used in laboratory setups and industrially in the data transmission of single photon signals. This relates in particular to fiber optics-based networks for “entanglement distribution” or “quantum key distribution”. In addition to the application in a node of the network, in which the fluorescence signal of qubits is converted by the invention, the invention can be used in so-called “trusted repeaters”. These are repeater stations which can be interleaved with the nodes of the transmitter and receiver in order to realize tap-proof data transmission between them.

Although some aspects of the present invention have been described as features related to a device, it is clear that such a description can also be considered as a description of corresponding features of a method. Although some aspects have been described as features related to a method, it is clear that such a description can also be considered as a description of corresponding features of a device or functionality of a device.

In the above detailed description, various features have partly been grouped together in embodiments to rationalize the invention. This type of the invention is not to be interpreted as intending that the claimed embodiments have more features than are explicitly indicated in each claim. Rather, as the following claims reflect, subject-matter may be in less than all of the features of any single disclosed example. Consequently, the following claims are hereby incorporated into the detailed description, wherein each claim may stand as its own separate example. While each claim may stand as its own separate example, it is to be noted that although dependent claims in the claims refer back to a specific combination with one or more other claims, other embodiments also include a combination of dependent claims with the subject-matter of any other dependent claim or a combination of any feature with other dependent or independent claims. Such combinations are included unless it is stated that a specific combination is not intended. It is further intended that a combination of features of a claim with any other independent claim also be encompassed even if that claim is not directly dependent on the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] A. Dahlberg, M. Skrzypczyk, T. Coopmans, L. Wubben, F. Rozpędek, M. Pompili, A. Stolk, P. Pawełczak, R. Knegjens, J. d. O. Filho, R. Hanson, S. Wehner 2019, 159.
[2] Y. Yu, F. Ma, X.-Y. Luo, B. Jing, P.-F. Sun, R.-Z. Fang, C.-W. Yang, H. Liu, M.-Y. Zheng, X.-P. Xie, W.-J. Zhang, L.-X. You, Z. Wang, T.-Y. Chen, Q. Zhang, X.-H. Bao, J.-W. Pan, Nature 2020, 578, 240.
[3] R. Ikuta, T. Kobayashi, S. Yasui, S. Miki, T. Yamashita, H. Terai, M. Fujiwara, T. Yamamoto, M. Koashi, M. Sasaki, Z. Wang, N. Imoto, Opt. Express 2014, 22, 11205.
[4] A. Dreau, A. Tcheborateva, A. E. Mahdaoui, C. Bonato, R. Hanson, Phys. Rev. Applied 2018, 9.
[5] P. C. Strassmann, A. Martin, N. Gisin, M. Afzelius, Opt. Express 2019, 27, 14298.
[6] H. Rutz, K.-H. Luo, H. Suche, C. Silberhorn, Appl. Phys. B 2016, 122.
[7] Arlee Smith, SNLO_help, https://www.as-photonics.com/snlo_files/SNLO_help.pdf 2015.
[8] S. L. Todaro, V. B. Verma, K. C. McCormick, D. T. C. Allcock, R. P. Mirin, D. J. Wineland, S. W. Nam, A. C. Wilson, D. Leibfried, D. H. Slichter, Physical review letters 2021, 126, 10501.
[9] L. Robledo, L. Childress, H. Bernien, B. Hensen, P. F. A. Alkemade, R. Hanson, Nature 2011, 477, 574.
[10] S. L. McCall, A. F. J. Levi, R. E. Slusher, S. J. Pearton, R. A. Logan.
[11] T. J. Kane, R. L. Byer, Optics letters 1985, 10, 65.
[12] R. W. P. Drever, J. L. Hall, F. V. Kowalski, J. Hough, G. M. Ford, A. J. Munley, H. Ward, Appl. Phys. B 1983, 31, 97.
[13] T. W. Hansch, B. Couillaud, Optics Communications 1980, 35, 441.
[14] Dmitriev, Handbook of Non-linear Optical Crystals (1999).
[15] Kato, IEEE JQE v22 p 1013 (1986); red modification by Zhang, Opt Comm, v184 p 485 (2000).
[16] Eimerl, J. Appl. Phys. v62 p 1968 (1987).
[17] Edwards, Opt. Quant. Electron. v16 p 373 (1984).
[18] Jundt, Opt. Lett. v22, p 1553 (1997).
[19] Zelmon, JOSA B v14 p 3319 (1997).
[20] Vanherzeele, Appl. Opt. v27 p 3314 (1988).
[21] Wiechmann, Opt. Lett. v18 p 1208 (1993).
[22] Kato, IEEE JQE v30 p 2950 (1994).
[23] Umemura et al. Opt. Mater. v30 p 532 (2007).
[24] Kato, CLEO 2004.
[25] Kato, Appl. Opt. v41 p 5040 (2002).
[26] Koechner, W. (1976). Solid state laser engineering. New York: Springer-Verlag
[27] G. C. Bhar, et. al. A comparative study of laser-induced surface damage thresholds in BBO crystals and effect of impurities, Optical Materials, Volume 27, Issue 1, 2004, pages 119-123, ISSN 0925-3467.
[28] Kan, H., Zhang, S., Zhai, K., Ma, X., Luo, Y., Hu, M., & Wang, Q. (2016). Femtosecond-induced micostructures in magnesium-doped lithium niobate crystals with high repetition rate. Optics Communications, 361, 175-180.
[29] Zverev, G., Levchuk, E., Pashkov, V., Poryadin, Y. (1972). LASER-RADIATION-INDUCED DAMAGE TO THE SURFACE OF LITHIUM NIOBATE AND TANTALATE SINGLE CRYSTALS, Soviet Journal of Quantum Electronics, 2, 167
[30] Pengchao Hu, Lianhan Zhang, Jing Xiong, Jigang Yin, Chengchun Zhao, Xiaoming He, Yin Hang, Optical properties of MgO doped near-stoichiometric LiTaO3 single crystals, Optical Materials, volume 33, issue 11, 2011, pages 1677-1680, ISSN 0925-3467, https://doi.org/10.1016/j.optmat.2011.05.007.
[31] Fang, S., et. al. Growth and optical properties of Mg, Fe Co-doped LiTaO3 crystal. Optics, volume 117, 2006, pages 72-76.

1. A device for frequency conversion of electromagnetic radiation, the device comprising a non-linear medium, the device being configured to superimpose electromagnetic input radiation of a first wavelength in the non-linear medium with electromagnetic driving radiation of a second wavelength along a propagation path in order to generate electromagnetic output radiation of a third wavelength,
wherein the second wavelength is greater than the first wavelength,
wherein the second wavelength is smaller than the third wavelength, and
wherein the non-linear medium is configured for free propagation of the driving radiation in the non-linear medium.

2. The device according to claim 1, wherein a power of the input radiation is lower than a power of the driving radiation.

3. The device according to claim 1, wherein a power of the input radiation is smaller by at least a factor of 10⁸ than a power of the driving radiation.

4. The device according to claim 1, wherein the device comprises a resonator resonant for the second wavelength, wherein the propagation path of the non-linear medium is arranged in the resonator to provide the driving radiation along the propagation path.

5. The device according to claim 3, configured to generate the output radiation based on a process of three-wave mixing of the input radiation, the output radiation and the driving radiation.

6. The device according to claim 1, wherein the device is configured to focus the driving radiation in the non-linear medium to a focus comprising a cross-sectional size of 2*w₀, and
wherein a length L of the non-linear medium along the propagation path fulfills the following condition:
$$L \leq {z}_{R} * \sqrt{\frac{1}{3} {( \frac{D}{{w}_{0}} )}^{2} - 4}$$
where z_{R} denotes the Rayleigh length for the driving radiation, and D denotes a diameter of an aperture of the non-linear medium.

7. The device according to claim 1, wherein the non-linear medium comprises a length along the propagation path in a range from 2 mm to 60 mm.

8. The device according to claim 1, wherein the device is configured to focus the driving radiation in the non-linear medium, wherein the Rayleigh length of the focus of the driving radiation in the non-linear medium is at most the Rayleigh length of a corresponding Gaussian beam.

9. The device according to claim 1, wherein the device is configured to focus the driving radiation to a focus in the non-linear medium, wherein the device is configured to provide the driving radiation in the focus with a power density of at least 2/π·10⁵ W/cm², or at least 2/π·10⁶ W/cm².

10. The device according to claim 1, wherein an aperture of the non-linear medium comprises a size of 0.5 mm to 10 mm in a first direction, and comprises a size of 0.5 mm to 10 mm in a second direction perpendicular to the first direction.

11. The device according to claim 1, wherein the non-linear medium comprises a uniform second-order electrical susceptibility along the propagation path.

12. The device according to claim 1, wherein the second order electrical susceptibility of the non-linear medium comprises a sign periodically changing along the propagation path.

13. The device according to claim 1, wherein an inlet facet and an outlet facet of the non-linear medium, between which the propagation path extends, each enclose an angle with a plane perpendicular to the propagation path in a range from 2° to 10°.

14. The device according to claim 1, wherein the device is configured to superimpose the input radiation in the non-linear medium with the driving radiation such hat the input radiation and the driving radiation match in their beam directions.

15. The device according to claim 1, wherein the third wavelength is in a range from 1260 nm to 1625 nm, wherein the sum of the reciprocals of the second and third wavelengths corresponds to the reciprocal of the first wavelength.

16. The device according to claim 1, further comprising:
a resonator resonant for the second wavelength, wherein the propagation path of the non-linear medium is arranged in the resonator to provide the driving radiation along the propagation path, and
a further resonator resonant for the second wavelength, in which a further propagation path is arranged which extends through a further non-linear medium, the device being configured to superimpose further electromagnetic input radiation with further electromagnetic driving radiation of the second wavelength along the further propagation path in order to generate further electromagnetic output radiation,
wherein the device is configured to use a portion of the driving radiation coupled out from the resonator to provide the further driving radiation in the further resonator.

17. The device according to claim 16, further comprising an amplifier, wherein the amplifier is configured to amplify the portion of the driving radiation coupled out from the resonator and to supply the amplified driving radiation to the further resonator so that the driving radiation in the resonator and the further driving radiation in the further resonator comprise the same intensity.

18. The device according to claim 1, wherein the material of the non-linear medium is one of beta barium borate, beta BaB₂O₄, lithium niobate, LiNbO₃ or MgO:LiNbO₃, potassium titanyl arsenate, KTiOAsO₄, potassium titanyl phosphate, KTiOPO₄, lithium triborate, LiB₃O₅, and bismuth triborate, BiB₃O₆.

19. The device according to claim 1,
wherein the third wavelength is in a range from 1260 nm to 1625 nm, and wherein the first wavelength is in a range from 200 nm up to half the third wavelength, or in a range from 600 nm to 650 nm.

20. The device according to claim 1 wherein the device is configured to maintain a temperature of the non-linear medium at a temperature T during operation, wherein T is between 0 °C and 200 °C,
wherein the material of the non-linear medium is potassium titanyl arsenate, KTiOAsO₄, and wherein a first crystallographic axis of the non-linear medium encloses an angle θ=90° with the propagation path and wherein a projection of the propagation path into a plane spanned by a second crystallographic axis and a third crystallographic axis of the non-linear medium encloses an angle φ with the second crystallographic axis, wherein the refractive index along the first crystallographic axis is greater than the refractive index along the third crystallographic axis, and wherein the refractive index along the third crystallographic axis is greater than the refractive index along the second crystallographic axis,
wherein the first wavelength is in a range from 350 nm to 840 nm, wherein the third wavelength is in a range from 1260 nm to 1675 nm, wherein the sum of the reciprocals of the second and third wavelengths corresponds to the reciprocal of the first wavelength, and wherein the second wavelength is smaller than the third wavelength, and wherein the following applies:
$$ϕ = {ϕ}_{0} + \frac{\partial ϕ}{\partial λ} Δλ + \frac{\partial ϕ}{\partial λ} \frac{\partial λ}{\partial T} Δ T$$
$$with$$
$$T = 80 °C + Δ T ; λ = 1064 nm + Δλ ; \\ {ϕ}_{0} = 33 ° \pm 1 ° ; \frac{\partial ϕ}{\partial λ} = - 0.9 ° / nm \pm 0.3 ° / nm ; and$$
$$\frac{\partial λ}{\partial T} = 0.05 nm / °C \pm 0.025 nm / °C .$$

21. The device according to claim 1, wherein the device is configured to maintain a temperature of the non-linear medium at a temperature T during operation, wherein T is between 0 °C and 200 °C,
wherein the material of the non-linear medium is potassium titanyl arsenate, KTiOAsO₄, and wherein a first crystallographic axis of the non-linear medium encloses an angle θ=90° with the propagation path and wherein a projection of the propagation path into a plane spanned by a second crystallographic axis and a third crystallographic axis of the non-linear medium encloses an angle φ with the second crystallographic axis, wherein the refractive index along the first crystallographic axis is greater than the refractive index along the third crystallographic axis, and wherein the refractive index along the third crystallographic axis is greater than the refractive index along the second crystallographic axis,
wherein the first wavelength is in a range from 600 nm to 700 nm or in a range from 635 nm to 640 nm and wherein the third wavelength is in a range from 1260 nm to 1675 nm, or
wherein the first wavelength is in a range from 635 nm to 640 nm and the third wavelength is in a range from 1530 nm to 1675 nm, and
wherein the sum of the reciprocals of the second and third wavelengths corresponds to the reciprocal of the first wavelength, and the following applies:
$$ϕ = {ϕ}_{0} + \frac{\partial ϕ}{\partial λ} Δλ + \frac{\partial ϕ}{\partial λ} \frac{\partial λ}{\partial T} Δ T$$
$$with$$
$$T = 80 °C + Δ T ; λ = 1064 nm + Δλ ; \\ {ϕ}_{0} = 33 ° \pm 1 ° ; \frac{\partial ϕ}{\partial λ} = - 0.9 ° / nm \pm 0.1 ° / nm ; and$$
$$\frac{\partial λ}{\partial T} = 0.05 nm / °C \pm 0.015 nm / °C .$$

22. The device according to claim 1, configured to convert single photons of the input radiation into photons of the output radiation while preserving quantum information.

23. The device according to claim 1, further comprising a filter arrangement arranged in a beam path of the output radiation, wherein the filter arrangement is configured to transmit the output radiation and to suppress the driving radiation.

24. The device according to claim 23, wherein the filter arrangement is configured to attenuate the driving radiation by at least a factor of 10⁶ or by a factor of 10⁸.

25. The device according to claim 1, further comprising a polarization filter arrangement arranged in a beam path of the output radiation, wherein the polarization filter arrangement is configured to suppress electromagnetic radiation comprising a polarization perpendicular to a polarization direction of the output radiation.

26. A method for frequency conversion of electromagnetic radiation, comprising:
superpositioning electromagnetic input radiation of a first wavelength with electromagnetic driving radiation of a second wavelength along a propagation path in a non-linear medium to generate electromagnetic output radiation of a third wavelength such that the second wavelength is longer than the first wavelength, such that the second wavelength is smaller than the third wavelength and such that the driving radiation propagates freely in the non-linear medium.
